(19) United States
(12) Patent Application Publication
(10) Pub. No.: US 2010/0183873 A1
(43) Pub. Date: Jul. 22, 2010

(54) Strechable film

(76) Inventor: Vadim Korniychik, Brooklyn, NY (US)

Correspondence Address: Anna Vishev, 44 Cortelyou Avenue, Staten Island, NY, 10312, US

(21) Appl. No.: 12/584,823

(22) Filed: Sep. 14, 2009

(30) Foreign Application Priority Data
Jan. 19, 2009 (RU) 2009101547

(51) Int. Cl. C09J 7/02

(52) U.S. Cl. 428/343

(57) ABSTRACT

A film for protection of various surfaces includes a film base stretchable at least three times its size and a glue layer applied to one side of the stretchable film base. The film can be removably affixed to a protected surface, and the glue layer does not leave a residue when the film is removed from the protected surface.

### CROSS-REFERENCE TO RELATED APPLICATIONS

This application claims all rights of priority to Russian Patent Application No. 2009101547, which was filed on Jan. 19, 2009, and the disclosure of which is incorporated herein by reference.

### BACKGROUND

This invention is related to the general field of production of items utilized in painting jobs. Currently, people skilled in the art are familiar with the film like the one produced by ULINE company (available at http://www.uline.com/BL_{—}8603/Uline-Cast-High-Performance-Mashine-Length-Stretch-Film) and can be used as a prototype.

Film-prototype has the ability to extend its linear size for up to three times. However, using it for painting jobs as a covering material for automobiles, residential houses, commercial buildings, etc. is difficult due to the fact of having to use additional adhesive materials with it such as SCOTCH tape, for example the one produced by 3M (available at http://solutions.3m/wps/portal/3M/en_US/painting_masking/painting_masking/product_informat ion/tape_selector/).

### SUMMARY

It is a general object of the present invention to widen the functionality of a film. This object is achieved by applying certain glue, like the one used in 3M's SCOTCH tape, onto one of the sides of the film.

### DETAILED DESCRIPTION

In the preferred embodiment, the invention is a stretchable film with a layer of glue applied to one of its sides.

The common element of the prototype and the present invention is the ability to stretch its size up to 3 times. The difference from the prototype is the ability of the film of the present invention to be glued onto surfaces, which need to be protected from paint during painting, and its ability to easily come off those surfaces after being used, without leaving any residue.

Furthermore, the invented film can also protect covered surfaces under pressure, such as painting using specific pressure equipment. This type of film can be issued in the form of rolls or special kits, for example kits for painting automobiles, resembling different parts of car surfaces. This type of a kit should contain precut film-forms of different car parts, such as a windshield, a door, etc, in the size that is 3 times smaller than the size of the actual parts. There can also be the kits for houses and buildings, in which the precut shapes of the film will resemble different shapes of windows. Using of such film reduces the time spent for covering surfaces by 5-10 times, therefore reducing the time needed for actual painting, reducing costs associated with painting and increasing efficiency.

The effectiveness of such film is specifically apparent when covering 3-dimentional surfaces with more difficult configurations. The glue layer of such film quickly affixes to the surfaces. In the rolls of film the glue could be applied in chess order, or in diagonal shapes, as well as along the edges.

What is claimed is:

1. A film for protection of various surfaces, the film comprising:
a film base stretchable at least three times its size; and
a glue layer applied to one side of the stretchable film base such that the film is operable to be removably affixed to a protected surface, wherein the glue layer does not leave a residue when the film is removed from the protected surface.

2. A kit comprising:
a plurality of pre-cut film shapes, each precut film shape including
a film base stretchable at least three times its size; and
a glue layer applied to one side of the stretchable film base such that the pre-cut film shape is operable to be removably affixed to a protected surface, wherein the glue layer does not leave a residue when the pre-cut film shape is removed from the protected surface.
